(19) United States
(12) Patent Application Publication
(10) Pub. No.: US 2014/0188979 A1
(43) Pub. Date: Jul. 3, 2014

(54) REAL-TIME DIGITAL CONTENT SHARING SYSTEM AND METHOD

(71) Applicant: SPRING HOUSE ENTERTAINMENT TECHNOLOGY, (US)

(72) Inventor: JUNG-KUEI CHANG, Taipei City (TW)

(73) Assignee: SPRING HOUSE ENTERTAINMENT TECHNOLOGY INC., Taipei City (TW)

(21) Appl. No.: 13/731,932

(22) Filed: Dec. 31, 2012

(51) Int. Cl. H04L 29/06

(52) U.S. Cl. CPC H04L 67/42
USPC 709/203

(57) ABSTRACT

A real-time digital content sharing system and method are disclosed. The system comprises a sharing terminal, at least one receiving terminal, and a sharing server that is connected with the sharing terminal and the at least one receiving terminal via a network. The sharing server is used to store plural digital content items for the sharing terminal to download and use and is controlled by the sharing terminal to display/play the digital content downloaded and used by the sharing terminal in the at least one receiving terminal. In this way, users can synchronically share the authorized digital content with their friends without the risk of copyright infringement. Thereby, it is not only able to strengthen the social relationships among the users and their friends, but it also able to make rapid distribution of the digital content.

### TECHNICAL FIELD

The present invention relates to a digital content sharing system and method, and, more particularly, to a real-time digital content sharing system and method able for users to share their authorized digital content synchronically with their friends without the risk of copyright infringement. Thereby, it is not only able to strengthen the social relationships among the users and their friends, but it also able to make a rapid distribution of the digital content.

### BACKGROUND

With the rapid development of computer technology and the widespread application of Internet, for most people in their daily lives, it is indispensable to use various electronic devices via Internet to read electronic books online, watch videos, or listen to music. However, a real-time sharing mechanism is still not available for users to share with their friends the electronic books they read, the videos they watch, or the music they listen to. The reasons are as follows.

First of all, the real-time sharing mechanism cannot be carried out by existing instant messaging software. With the easy access to Internet, there are various kinds of messaging software in the market, such as MSN, Yahoo Messenger, or various updated apps at present time. Instant communication is usually carried out by three ways, that is, by text-based, voice-based, or video-based instant messaging. Although bi-directional communication could be established by these ways, it contributes a little or nothing to share digital content synchronically.

Secondly, existing sharing mechanism may incur a risk of copyright infringement. As mentioned above, the messaging software is not capable of sharing digital content synchronically. When a user is desired to share with friends some digital content (such as electronic book, videos, or music), the only way is to send the files directly to friends. However, most digital content items are copyrighted. When a user is authorized to use the copyrighted digital content, it does not guarantee that the user is authorized to distribute the copyrighted digital content to others. In other words, distribution of digital content via messaging software might be risky in copyright infringement.

In order to overcome above shortcomings, inventor had the motive to study and develop the present invention to provide a real-time digital content sharing system and method able for users to share their authorized digital content synchronically with their friends without the risk of copyright infringement. Thereby, it is not only able to strengthen the social relationships among the users and their friends, but it also able to make a rapid distribution of the digital content and thus to increase the popularity of the digital content.

### SUMMARY OF THE DISCLOSURE

An object of the present invention is to provide a real-time digital content sharing system and method for users to share their authorized digital content synchronically with their friends without the risk of copyright infringement. Thereby, it can not only strengthen the social relationships among the users and their friends, but also make a rapid distribution of the digital content.

In order to achieve above object, the present invention provides a real-time digital content sharing system comprising a sharing terminal, at least one receiving terminal, and a sharing server. The sharing server is connected with the sharing terminal and the at least one receiving terminal via a network and used for storing plural digital content items; wherein the sharing terminal downloads the digital content from the sharing server and uses it, and controls the sharing server to display/play the digital content downloaded and used by the sharing terminal in the at least one receiving terminal.

In implementation, the sharing terminal further comprises a user interface module used for controlling the sharing server to display/play the digital content downloaded and used by the sharing terminal in the at least one receiving terminal. In one embodiment, the user interface module comprises a window list and a control window. The window list shows the at least one receiving terminal to the sharing terminal to check the connection status of the at least one receiving terminal and is used for the sharing terminal to select one or more receiving terminal the sharing terminal desires to share with. The control window is used for the sharing terminal to select one or more digital content items the sharing terminal desires to share.

In implementation, the digital content is in a form of video data, audio data, image data, electronic book data, web data, or software data.

In implementation, the real-time digital content sharing system further comprises an image acquisition module and the image acquisition module is used for real-timely capturing one or more images of the digital content displayed/played in the sharing terminal and transmitting the captured images to the sharing server, where the transmitted images are displayed/played by the sharing server in the at least one receiving terminal synchronically.

In implementation, the sharing terminal further comprises an instant messaging module used for establishing a real-time communication between the sharing terminal and the at least one receiving terminal. The instant messaging module is used for exchanging text messages, voice/video messages, or instant drawing/doodling.

The present invention also provides a real-time digital content sharing method, comprising steps of: Step A1: a sharing terminal downloading at least one of plural digital content items stored in a sharing server; and Step A2: the sharing terminal using the downloaded digital content and controlling the sharing server to display/play synchronically the digital content used by the sharing terminal in the at least one receiving terminal.

In implementation, the Step A1 further comprises steps of: Step A10: a sharing terminal sending to a sharing server a request for downloading at least one of plural digital content items stored in the sharing server; and Step A15: the sharing server transmitting the digital content to the sharing terminal according to the request when the sharing server confirming that the sharing terminal is authorized to download the digital content.

In implementation, the Step A2 further comprises steps of: Step A20: the sharing terminal sending a first sharing request to the sharing server while using the downloaded digital content, where the first sharing request includes information regarding which digital content is to be shared and with which receiving terminal the digital content is shared; and Step A25: the sharing server receiving the first sharing request from the sharing terminal and displaying/playing the digital content in the receiving terminal according to the first sharing request.

In implementation, the Step A20 further comprises steps of: Step A21: the sharing terminal producing a first sharing request by selecting one or more receiving terminals from a receiving terminal list and determining which digital content is desired to share when using the downloaded digital content and; and Step A22: the sharing terminal sending the first sharing request to the sharing server.

In implementation, the Step A20 further comprises steps of: Step A23: one or more receiving terminals sending a second sharing request to the sharing terminal when the sharing terminal using the downloaded digital content; and Step A24: the sharing terminal producing a first sharing request when confirming the second sharing request, and then sending the first sharing request to the sharing server.

In implementation, the Step A25 further comprises steps of: Step A26: the sharing server receiving the first sharing request from the sharing terminal and sending back a confirmation request to the sharing terminal; and Step A27: the sharing server synchronically displaying/playing the digital content in the receiving terminal according to the first sharing request when the sharing terminal response to confirm the confirmation request.

In implementation, the Step A2 further comprises steps of Step A28: capturing one or more images of the digital content displayed/played in the sharing terminal by an image acquisition module when the sharing terminal using the downloaded digital content; and Step A29: transmitting the captured images to the sharing server and synchronically displaying/playing the captured images by the sharing server in the at least one receiving terminal.

The following detailed description, given by way of examples or embodiments, will best be understood in conjunction with the accompanying drawings.

### BRIEF DESCRIPTION OF THE DRAWINGS

FIG. 1 is a block diagram showing a first embodiment of a real-time digital content sharing system of the present invention.

FIG. 1A is a block diagram showing the use of the first embodiment of the real-time digital content sharing system of the present invention.

FIG. 1B is another block diagram showing the use of the first embodiment of the real-time digital content sharing system of the present invention.

FIG. 2 is a block diagram showing a second embodiment of a real-time digital content sharing system of the present invention.

FIG. 2A is a block diagram showing the use of the second embodiment of the real-time digital content sharing system of the present invention.

FIG. 2B is another block diagram showing the use of the second embodiment of the real-time digital content sharing system of the present invention.

FIG. 2C is a schematic view showing the user interface module in the second embodiment of the real-time digital content sharing system of the present invention.

FIG. 3 is a flowchart showing the steps of a real-time digital content sharing method of the present invention.

### DETAILED DESCRIPTION

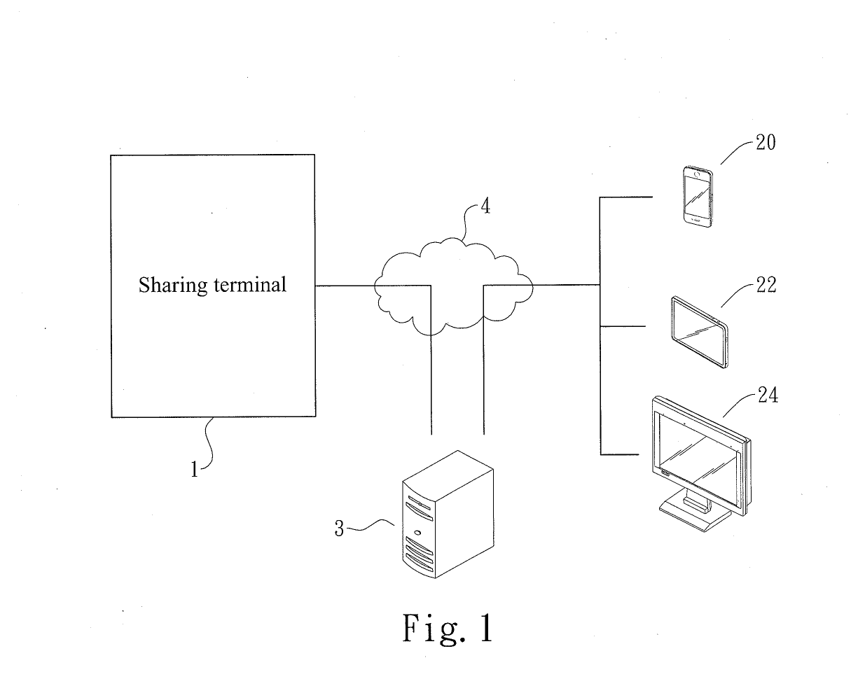

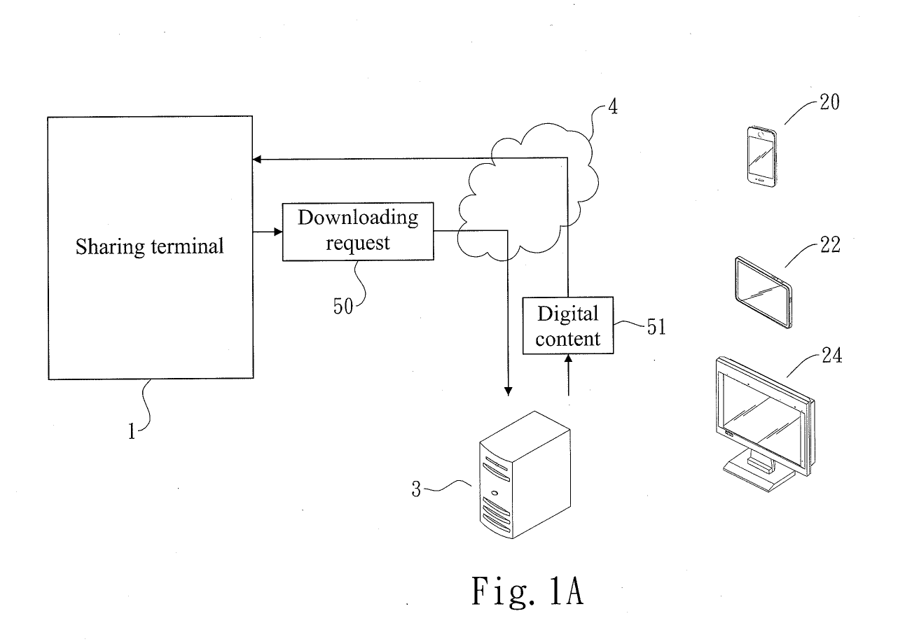

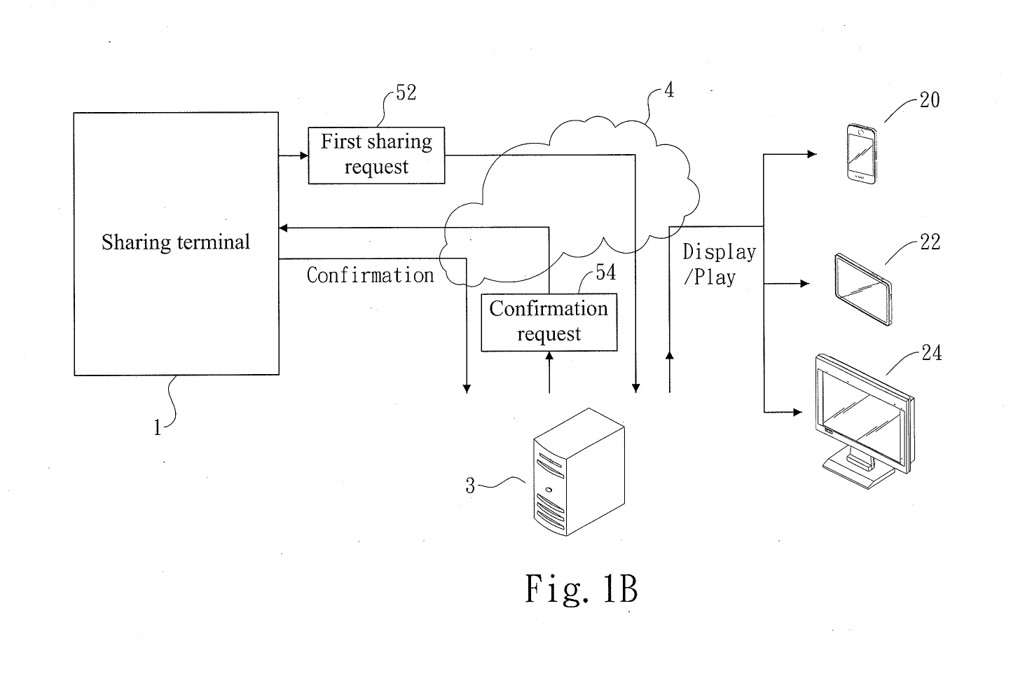

Please refer to FIG. 1, which is a block diagram showing a first embodiment of a real-time digital content sharing system according to the present invention. As shown in FIG. 1, the real-time digital content sharing system comprises a sharing terminal 1, three receiving terminals 20, 22, 24, and a sharing server 3. The sharing server 3 is connected with the sharing terminal 1 and the three receiving terminals 20, 22, 24 via a network. Besides, the sharing server 3 is used to store plural digital content items for the sharing terminal 1 to download and use.

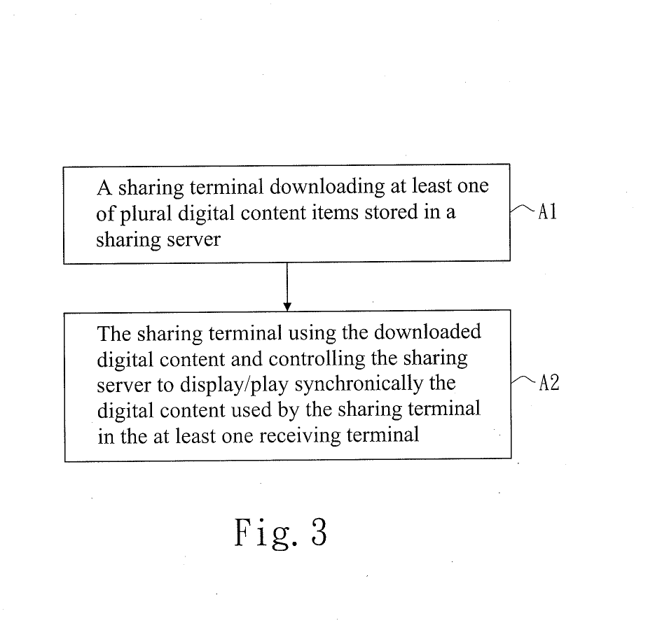

Moreover, the present invention also discloses a real-time digital content sharing method corresponding to the real-time digital content sharing system. Please refer to FIG. 3, which shows the flowchart of the steps of the real-time digital content sharing method. As shown in FIG. 3, in Step A1, the sharing terminal 1 downloads at least one of plural digital content items stored in the sharing server 3. Afterward, in Step A2, the sharing terminal 1 uses the downloaded digital content and controls the sharing server 3 to display/play synchronically the digital content used by the sharing terminal 1 to the three receiving terminals 20, 22, 24.

In this embodiment, the digital content stored in the sharing server 3 is in a form of video data, audio data, image data, electronic book data, web data, or software data. Besides, the users in the sharing terminal and in the receiving terminals can use any electronic devices that are accessible to Internet and are provided with display screens, such as smart phones, desktop computers, notebook computers, tablet computers, personal digital assistants, or other devices having similar functions.

Besides, the synchronic display/play of the digital content in the receiving terminals is performed in a passive way and cannot be controlled by the receiving terminals. In other words, the sharing server only synchronically shares the digital content displayed/played in the sharing terminal with the receiving terminals. However, the receiving terminals cannot download the digital content from the sharing server. Therefore, during this sharing process, the sharing terminal controls the display/play of the digital content. Consequently, if the sharing terminal pauses or stops the use of the digital content (for example, to pause or stop watching movie), the synchronic display/play in the receiving terminals would be paused or stopped at the same time.

Moreover, for different types of the digital content, different means are correspondingly used to display/play the digital content in the receiving terminals. For example, when the digital content is in a form of video data or audio data, the digital content can be displayed/played in the receiving terminals by means of streaming video or streaming audio. If the digital content in a form of pictures, electronic books, or website, the digital content can be shown page by page. In this case, whenever one page is shown in the sharing terminal, the sharing server will show this page synchronically in the receiving terminals. If the digital content were in a form of software data, other suitable means would be required for synchronical sharing, which would be detailed in the following.

In implementation, the Step A1 of the real-time digital content sharing method further comprises two other steps: Step A10 and Step A15. In Step A10, as shown in FIG. 1A, the sharing terminal 1 firstly sends a request 50 for downloading at least one of plural digital content items to the sharing server 3 storing the plural digital content items. After that, in Step A15, the sharing server 3 will confirm whether the sharing terminal 1 is authorized to download the digital content first. When the sharing server 3 confirms the sharing terminal is authorized, it will transmit the digital content 51 to the sharing terminal 1 according to the request 50. By above two steps, it is able to ensure the copyrighted content is used by authorized users.

Regarding the display/play of digital content to the receiving terminals, Step A2 further comprises Step A20 and Step A25. In Step 20, as shown in FIG. 1B, when the sharing terminal 1 uses the downloaded digital content, it sends a first sharing request 52 to the sharing server 3, where the first sharing request includes the information regarding which digital content is to be shared and with which receiving terminal the digital content is shared. After that, in Step A25, when the sharing server 3 receives the first sharing request 52 from the sharing terminal 1, it will display/play the digital content to the receiving terminals 20, 22, 24 according to the first sharing request 52.

Regarding the subject to be shared with and the digital content to be shared (Step A20), there might be two possible situations. In the first situation, the subject to be shared with and the digital content to be shared are all determined by the sharing terminal. In the second situation, the receiving terminals are able to ask the sharing terminal to sharing digital content. These situations will be detailed hereinafter.

Regarding the fulfillment of the first sharing request by the sharing server, Step A25 further comprises Step A26 and Step A27. In Step A26, as shown in FIG. 1B, when the sharing server 3 receives the first sharing request 52 from the sharing terminal 1, it will send a confirmation request 54 to the sharing terminal 1. After that, when the sharing terminal 1 receives the confirmation request 54, it will make a confirmation right away. When the sharing terminal 1 confirms the confirmation request, it will response to confirm to the sharing server, and the sharing server 3 will synchronically display/play the digital content used by the sharing terminal 1 to the receiving terminals 20, 22, 24 according to the first sharing request 52.

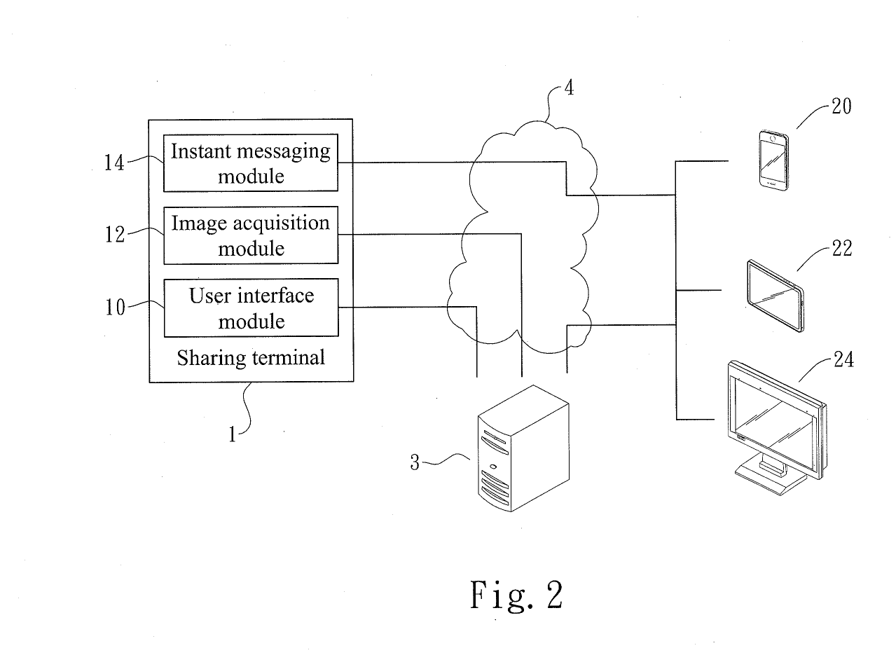

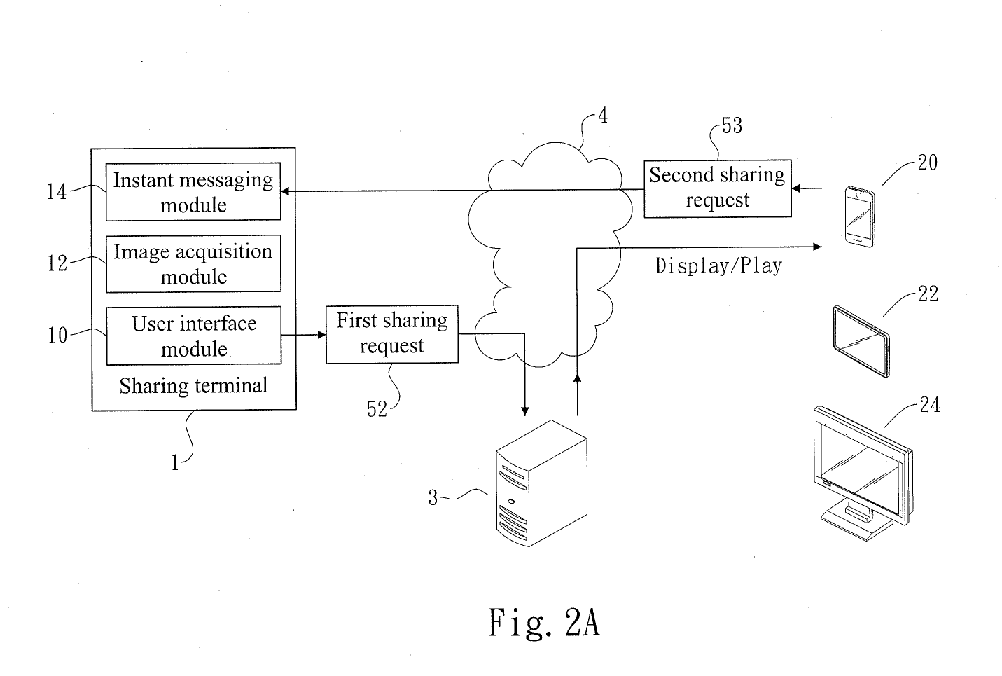

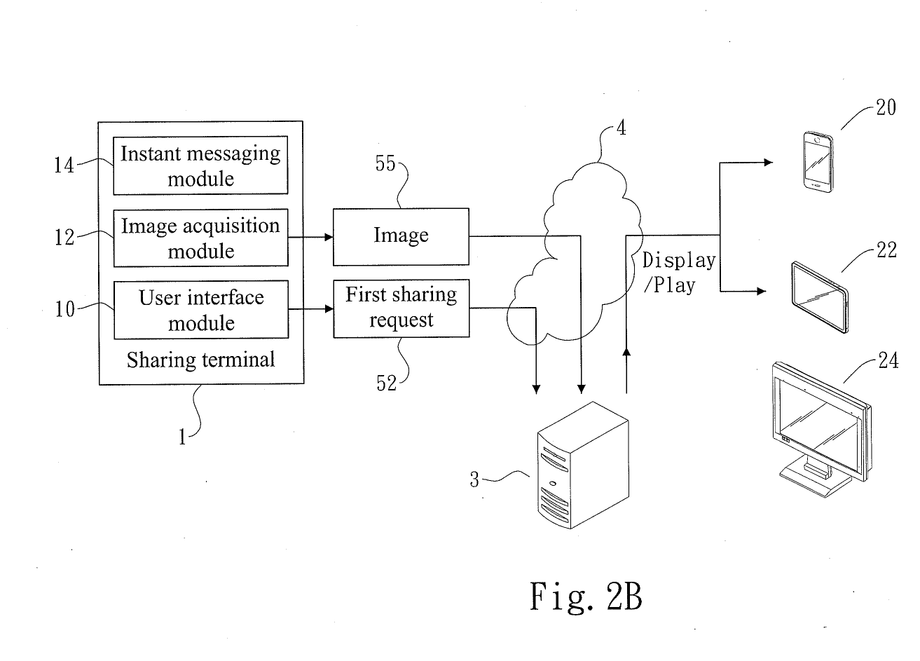

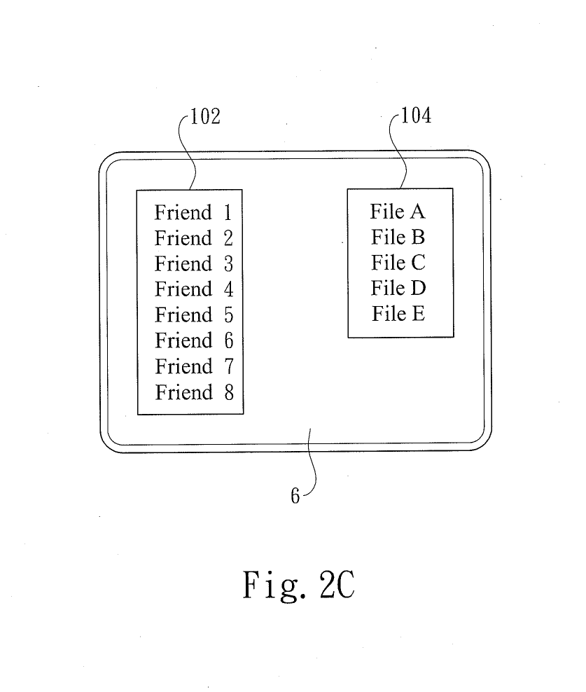

Please refer to FIG. 2, which shows a second embodiment of the real-time digital content sharing system according to the present invention. As shown in FIG. 2, the real-time digital content sharing system comprise a sharing terminal 1, three receiving terminals 20, 22, 24, and a sharing server 3. Compared with the first embodiment, in the second embodiment, the sharing terminal 1 further comprises a user interface module 10, an image acquisition module 12, and an instant messaging module 14.

As mentioned above, there are two situations regarding how to determine the subject to be shared with and the digital content to be shared, and the first situation would be detailed here. In the first situation, Step A20 further comprises Step A21 and Step A22. In Step A21, as shown in FIGS. 2B and 2C, when the sharing terminal 1 uses the downloaded digital content, it would produce a first sharing request 52 by selecting the subject (one or more than one receiving terminal) to be shared with from a list of the at least one receiving terminal and determining which digital content is desired to be shared. After that, in Step A22, the sharing terminal 1 will send the first sharing request 52 to the sharing server 3.

The subject to be shared with and the digital content to be shared can be determined by using the user interface module 10 in this embodiment. By using the user interface module 10, the sharing terminal 1 can control the sharing server 3 to display/play the digital content the sharing terminal desires to share to the receiving terminals the sharing terminal desires to share with. By this way, the sharing terminal 1 can determine the subject to be shared with and the digital content to be shared. In implementation, various means can be used to achieve this goal and one example will be provided for illustration.

Please refer to FIG. 2C, where a display screen 6 is provided in the sharing terminal. As shown in FIG. 2C, the user interface module further comprises a window list 102 and a control window 104. The window list 102 shows the at least one receiving terminal to the sharing terminal to check the connection status of the at least one receiving terminal and is used by the sharing terminal to select the subject to be shared with. The control window 104 is used for the sharing terminal to select one or more digital content items the sharing terminal desires to share.

The image acquisition module 12 is used for real-timely capturing one or more images of the digital content displayed/played in the sharing terminal. For example, if the sharing terminal downloads and executes certain software (such as gaming software), the image acquisition module 12 can capture the images shown in the display screen of the sharing terminal for the sharing terminal to share these images with the receiving terminals. Although the image acquisition module 12 is provided in the sharing terminal, it also can be provided in any remote terminal when in implementation.

Moreover, the image acquisition module 12 also can be used by the sharing terminal to share the notes regarding the used digital content. For example, when the sharing terminal reads an electronic book and takes notes on a certain page, the image of this page with the notes can be captured by the image acquisition module to share with the receiving terminals. However, the notes also can be synchronically shown in an alternative way, that is, a synchronically presenting module used to show the input contents (including the hand-writing input) synchronically to the users in the receiving terminals.

Regarding the display/play of digital content in the receiving terminals, in this embodiment, Step A2 further comprises Step A28 and Step A29. In Step A28, as shown in FIG. 2B, an image acquisition module 12 is used to capture images 55 of the digital content displayed/played in the sharing terminal when the sharing terminal using the downloaded digital content. After that, these captured images 55 are transmitted to the sharing server 3 and the sharing server would synchronically display/play the captured images in the at least one receiving terminal.

The instant messaging module 14 is used to establish a real-time communication between the sharing terminal and the at least one receiving terminal. The instant messaging module 14 can be used to exchange text messages, voice/video messages, or instant drawing/doodling. Via this real-time communication, the receiving terminals can ask the sharing terminal to share certain digital content by sending a request to the sharing terminal or can return feedback regarding the shared digital content to the sharing terminal. Such feedback is bi-directional between the sharing terminal and the receiving terminals. For example, when the sharing terminal and the receiving terminal are synchronically reading an electronic book, they can discuss and exchange their remarks with each other.

As mentioned above, there are two situations regarding the subject to be shared with and the digital content to be shared. The second situation will be detailed here. In the second situation, Step A20 further comprises Step A23 and Step A24. In Step A23, as shown in FIG. 2A, when the sharing terminal 1 uses the downloaded digital content, the receiving terminal 22 sends a second sharing request 53 to the sharing terminal 1. After that, in Step A24, the sharing terminal 1 produces a first sharing request 52 when it confirms the second sharing request 53, and sends the first sharing request 52 to the sharing server 3, by which the sharing server 3 is controlled to display/play digital content in the receiving terminal.

In this embodiment, as shown in FIG. 2A, the second sharing request 53 from the receiving terminal 20 is transmitted to the sharing terminal 1 via the real-time communication. However, alternatively, the second sharing request 53 also can be transmitted to the sharing terminal via the sharing server 3. Moreover, when the real-time communication is established between the sharing terminal and the receiving terminals, the sharing terminal also can show to the receiving terminals a resource list including the digital content items that can be shared. In this case, any receiving terminal can send a request for sharing a certain digital content item in the resource list.

As disclosed in above descriptions and attached drawings, the present invention provides a real-time digital content sharing system and method able for users to share their authorized digital content synchronically with their friends without the risk of copyright infringement. Thereby, it is not only able to strengthen the social relationships among the users and their friends, but it also able to make a rapid distribution of the digital content. It is novel and can be put into industrial use.

Although the embodiments of the present invention have been described in detail, many modifications and variations could be made by those skilled in the art from the teachings disclosed hereinabove. Therefore, it should be understood that any modification and variation equivalent to the spirit of the present invention be regarded to fall into the scope defined by the appended claims.

What is claimed is:

1. A real-time digital content sharing system, comprising:
a sharing terminal;
at least one receiving terminal; and
a sharing server, connected with the sharing terminal and the at least one receiving terminal via a network and used for storing plural digital content items;
wherein the sharing terminal downloads the digital content from the sharing server and uses it, and controls the sharing server to display/play the digital content downloaded and used by the sharing terminal in the at least one receiving terminal.

2. The real-time digital content sharing system as claimed in claim 1, wherein the sharing terminal further comprising a user interface module used for controlling the sharing server to display/play the digital content downloaded and used by the sharing terminal in the at least one receiving terminal.

3. The real-time digital content sharing system as claimed in claim 2, wherein the user interface module further comprises:
a window list, for showing the at least one receiving terminal to the sharing terminal to check the connection status of the at least one receiving terminal and for the sharing terminal to select one or more receiving terminal the sharing terminal desires to share with; and
a control window, for the sharing terminal to select one or more digital content items the sharing terminal desires to share.

4. The real-time digital content sharing system as claimed in claim 1, wherein the digital content is in a form of video data, audio data, image data, electronic book data, web data, or software data.

5. The real-time digital content sharing system as claimed in claim 1, further comprising an image acquisition module, used for real-timely capturing one or more images of the digital content displayed/played in the sharing terminal and transmitting the captured images to the sharing server, where the transmitted images are displayed/played by the sharing server in the at least one receiving terminal synchronically.

6. The real-time digital content sharing system as claimed in claim 1, wherein the sharing terminal further comprising an instant messaging module used for establishing a real-time communication between the sharing terminal and the at least one receiving terminal.

7. The real-time digital content sharing system as claimed in claim 6, wherein the instant messaging module is used for exchanging text messages, voice/video messages, or instant drawing/doodling.

8. A real-time digital content sharing method, comprising steps of:
Step A1: a sharing terminal downloading at least one of plural digital content items stored in a sharing server; and
Step A2: the sharing terminal using the downloaded digital content and controlling the sharing server to display/play synchronically the digital content used by the sharing terminal in the at least one receiving terminal.

9. The real-time digital content sharing method as claimed in claim 8, wherein the Step A1 further comprises steps of:
Step A10: a sharing terminal sending to a sharing server a request for downloading at least one of plural digital content items stored in the sharing server; and
Step A15: the sharing server transmitting the digital content to the sharing terminal according to the request when the sharing server confirming that the sharing terminal is authorized to download the digital content.

10. The real-time digital content sharing method as claimed in claim 8, wherein the Step A2 further comprises steps of:
Step A20: the sharing terminal sending a first sharing request to the sharing server while using the downloaded digital content, where the first sharing request includes information regarding which digital content is to be shared and with which receiving terminal the digital content is shared; and
Step A25: the sharing server receiving the first sharing request from the sharing terminal and displaying/playing the digital content in the receiving terminal according to the first sharing request.

11. The real-time digital content sharing method as claimed in claim 10, wherein the Step A20 further comprises steps of:
Step A21: the sharing terminal producing a first sharing request by selecting one or more receiving terminals from a receiving terminal list and determining which digital content is desired to share when using the downloaded digital content and; and
Step A22: the sharing terminal sending the first sharing request to the sharing server.

12. The real-time digital content sharing method as claimed in claim 10, wherein the Step A20 further comprises steps of:
Step A23: one or more receiving terminals sending a second sharing request to the sharing terminal when the sharing terminal using the downloaded digital content; and
Step A24: the sharing terminal producing a first sharing request when confirming the second sharing request, and then sending the first sharing request to the sharing server.

13. The real-time digital content sharing method as claimed in claim 10, wherein the Step A25 further comprises steps of:
Step A26: the sharing server receiving the first sharing request from the sharing terminal and sending back a confirmation request to the sharing terminal; and
Step A27: the sharing server synchronically displaying/playing the digital content in the receiving terminal according to the first sharing request when the sharing terminal response to confirm the confirmation request.

14. The real-time digital content sharing method as claimed in claim 8, wherein the Step A2 further comprises steps of:
Step A28: capturing one or more images of the digital content displayed/played in the sharing terminal via an image acquisition module when the sharing terminal using the downloaded digital content; and
Step A29: transmitting the captured images to the sharing server and synchronically displaying/playing the captured images by the sharing server in the at least one receiving terminal.
